(19) United States
(12) Patent Application Publication
(10) Pub. No.: US 2022/0152649 A1
(43) Pub. Date: May 19, 2022

(54) AN ALLOY INJECTION MOLDED LIQUID METAL SUBSTRATE

(71) Applicant: Hewlett-Packard Development, L.P., Spring, TX (US)

(72) Inventors: Chi Hao Chang, Taipei City (TW); Ya-Ting Yeh, Taipei City (TW); Chih-Hsiung Liao, Taipei City (TW); Kuan-Ting Wu, NanGang District (TW)

(73) Assignee: Hewlett-Packard Development, L.P., Spring, TX (US)

(21) Appl. No.: 17/423,992

(22) PCT Filed: May 7, 2019
(86) PCT No.: PCT/US2019/031019

§ 371 Date: Jul. 19, 2021

(51) Int. Cl. B05D 7/14; B22D 19/00; B22D 17/00; C23C 22/73; B05D 1/02; B05D 7/00; C25D 13/22

(52) U.S. Cl. CPC B05D 7/14; B22D 19/00; B22D 17/00; C25D 13/22; B05D 1/02; B05D 7/58; C23C 22/73

(57) ABSTRACT

Examples of an alloy injection molded liquid metal substrate are described. In an example, an alloy injection molded liquid metal substrate includes a liquid metal substrate and an alloy injection molded on a first surface of the liquid metal substrate.

### BACKGROUND

Electronic devices, such as mobile phones, tablets, laptops, and the like are housed within enclosures that are required to be both mechanically stable as well as aesthetically appealing. Such enclosures may be made of metal substrates. The outer surface of said substrate or enclosure or device, may be decorated to provide aesthetics to the device.

### BRIEF DESCRIPTION OF DRAWINGS

The following detailed description references the drawings, wherein:

FIG. 1 illustrates a sectional view of an alloy injection molded liquid metal substrate, according to an example of the present disclosure;

FIG. 2 illustrates a sectional view of an enclosure comprising the alloy injection molded liquid metal substrate, according to another example of the present disclosure;

FIG. 3 illustrates an electronic device with an enclosure comprising the alloy injection molded liquid metal substrate, according to an example of the present disclosure;

FIG. 4 illustrates a method of fabrication of the alloy injection molded liquid metal substrate, according to an example of the present disclosure.

FIG. 5 illustrates a method of fabrication of an enclosure comprising deposition of a decorative layer by electrophoretic deposition, according to an example of the present disclosure.

FIG. 6 illustrates a method of fabrication of an enclosure comprising deposition of a decorative layer by spray coating, according to an example of the present disclosure.

FIG. 7 illustrates a method of fabrication of an enclosure comprising passivation, according to an example of the present disclosure.

### DETAILED DESCRIPTION

### Definitions

For convenience, before further description of the present disclosure, certain terms employed in the specification, and examples are described here. These definitions should be read in the light of the remainder of the present disclosure. The terms used herein have the meanings recognized and known to those of skilled in the art, however, for convenience and completeness, particular terms and their meanings are set forth below.

The articles “a”, “an”, and “the” are used to refer to one or to more than one (i.e., to at least one) of the grammatical object of the article.

The term “about” when referring to a numerical value is intended to encompass the values resulting from variations that can occur during the normal course of performing a method. Such variations are usually within plus or minus 5 to 10 percent of the stated numerical value.

The term “liquid metal” refers to the class of amorphous alloys that are obtained by slow cooling rates.

The term “alloy” refers to the class material that may be referred to as a solid solution of metals. The alloy in the present disclosure refers to a magnesium alloy selected from AZ91D, AZ31B, LZ91, ALZ991, AI6063, AI80 or combinations thereof.

The term “molded”, and variations, such as “molding”, used herein refer to injection molding of alloy on a surface of liquid metal substrate.

The term “substrate”, used herein refers to the frame containing liquid metal that is usable to obtain the enclosure of the present disclosure. The substrate is noted to be compatible for die-cast or thixomolding techniques and structurally may be molded as per end use.

The term “injection molding”, used herein refers to the technique for manufacturing parts by injecting molten material into a mold. Herein, the term refers to injection molding of metal alloys onto a surface of liquid metal substrate. Injection molding may be carried out by a process, such as thixo-molding or die-casting.

The term “mechanically stable”, used herein refers to substrates having high tensile strength and/or high resistance to breakage and/or high corrosion resistance.

The term “high gloss edges”, used herein refers to chamfered surfaces (in particular the edges) of the substrate that reveal shiny edges.

Encasement or body of electronic devices are made of metal enclosures that require both strength and aesthetic appeal. Metal alloys, such as magnesium alloy substrates are prone to corrosion and, also suffer from poor tensile strength. However, their low density and compatibility with associated techniques, such as spray coating and/or electrophoretic deposition makes such alloys attractive choices for enhancing aesthetic appeal of substrates.

Enhancement of aesthetics is in particular desirable, for electronic encasement; and every endeavor in this regard is considered worthwhile. High gloss finish is particularly considered desirable, however the employment of metal substrates, such as magnesium alloys is noted to yield poorer finish. A lustrous over-coat is noted to be necessary for ensuring acceptable finish.

However, ensuring uniform glossy finish over the body of an electronic device may be challenging. The aesthetically pleasing rounded edges of laptops, tablets, mobile phones and the like, are noted to possess relatively inferior gloss finish, owing to surface corrosion occurring on CNC diamond cut chamfered areas of magnesium alloy materials. Liquid metal material can have much better durability against corrosion resistance and may be mechanically stable.

The present subject matter describes examples of injection molding an alloy on a surface of liquid metal substrate, the injection molded alloy additionally results in high tensile strength and thus, enhanced durability. In an example, the tensile strength of the alloy injection molded liquid metal substrate may be in a range of, from about 800 to about 1200 MPa as measured by American Society for Testing and Materials (ASTM) D790. This is found to be a clear enhancement from the primary component, i.e., the magnesium alloy having a tensile strength from about 40 to about 700 MPa. The alloy may be a magnesium alloy selected from AZ91D, AZ31B, LZ91, ALZ991, AI6063, AI80 or combinations thereof. The injection molding may be carried out by thixo-molding or die-casting at a temperature from about 800° C. to about 1650° C. The liquid metal substrate may be pre-fabricated into a suitable format or mold and the injection molding is carried out on the said mold. The molded alloy may have a thickness of, from about 0.3 mm to about 2.0 mm. The alloy having a thickness beyond 2.0 mm leads to substrates that are unsuitable for forming enclosures of electronic devices owing to excess weight. On the other hand, an alloy having a thickness lower than 0.3 mm is too weak and mechanically unstable.

Further, the molded alloy is readily adaptable to techniques, such as electrophoretic deposition or spray coating, thus allowing relatively easy deposition of a decorative layer that can provide enhancement of aesthetic appeal of the thus obtained enclosure. The decorative layer may have a thickness from about 6.0 μm to about 65.0 μm. Said enclosure is particularly suitable for electronic devices.

Further, chamfering of the alloy injection molded substrate, with or without decorative layer, may provide high gloss finish at the edges. Chamfering may be carried out by a CNC diamond cutting machine or a laser engraving machine. In an example, the chamfering may be carried out with a laser engraving machine having a Nd:YAG laser under a laser power from about 20 to about 200 W and an engraving speed from about 100 to about 300 mm/minute. In another example, the laser etching may be carried out under a laser power in a range from about 50 to about 150 W and an engraving speed from about 120 to about 280 mm/minute. In another example, the laser etching may be carried out at a laser power of about 100 W and an engraving speed of about 200 mm/minute. In another example, the chamfering may be carried out with a CNC diamond cutting machine at speed from about 6000 to about 25000 rpm. Chamfering results in an etching that reveals the underlying shiny liquid metal surface.

The aesthetic quality of thus obtained enclosures may be quantified by measuring a gloss value. In an example, the gloss value of the chamfered enclosure may be in a range from about 85 to about 97 units as measured by American Society for Testing and Materials (ASTM) D523 at a viewing angle of about 60°. This is found to be a clear enhancement from the unchamfered enclosures that result in a gloss value in the range from about 60 to about 75 units as measured by American Society for Testing and Materials (ASTM) D523 at a viewing angle of about 60°. In another example, the gloss value of the chamfered surface decoration layer may be in a range from about 87 to about 95 units as measured by ASTM D523 at a viewing angle of about 60°, Overall, the methodology of molding an alloy and the further deposition of a decorative layer on the alloy injection molded liquid metal substrate, according to the present subject matter, is simple and easy, and the enclosures thus obtained are aesthetically appealing, while also being mechanically stable.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

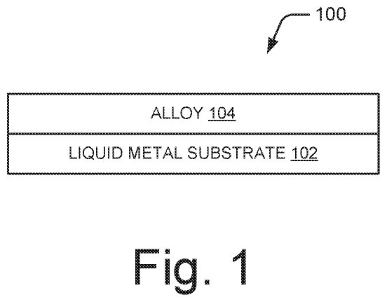

FIG. 1 illustrates a sectional view of an alloy injection molded liquid metal substrate 100, according to an example of the present disclosure. The alloy injection molded liquid metal substrate 100 includes a liquid metal substrate 102 and an alloy 104. The liquid metal substrate 102 may be made of titanium, aluminium, chromium, zirconium, tin, or combinations thereof. In an example, the liquid substrate 102 can be a combination of titanium and zirconium.

In an example, the liquid metal substrate 102 may be of a thickness in a range from about 0.3 to 2.0 mm. In an example, the liquid metal substrate 102 may be of a thickness in a range from about 0.5 to 1.8 mm. In another example, the liquid metal substrate 102 may be of a thickness of 1.1 mm.

In an example, the liquid metal substrate 102 may be made from an injection molding process.

As described above, the alloy injection molded liquid metal substrate 100 includes the alloy 104 injection molded on a first surface of the liquid metal substrate 102. The alloy may be molded on the first surface of the liquid metal substrate, such that a portion or the whole of the surface may be in contact with the alloy. The alloy may be a magnesium alloy selected from AZ91D, AZ31B, LZ91, ALZ991, AI6063, AI80 or combinations thereof. In an example, the alloy 104 can be AZ31B. In another example, the alloy 104 may be made of AZ91D.

The presence of liquid metal substrate 102 in the alloy injection molded liquid metal substrate 100 renders it mechanically stable. In an example, the alloy injection molded liquid metal substrate 100 may provide an enhanced tensile strength in a range from about 800 to about 1200 MPa. In another example, the alloy injection molded liquid metal substrate 100 may provide a tensile strength in a range from about 900 to about 1100 MPa. In another example, the alloy injection molded liquid metal substrate 100 may provide a tensile strength of about 1000 MPa,

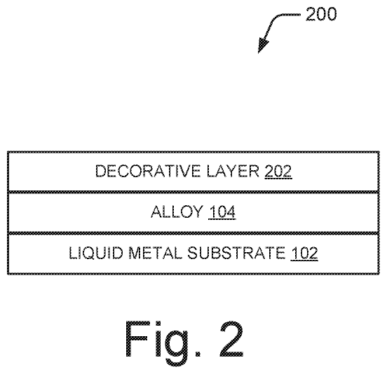

FIG. 2 illustrates a sectional view of an alloy injection molded liquid metal substrate 200, according to an example of the present disclosure. The alloy 104 that is injection molded on the first surface of the liquid metal substrate 102, as mentioned above, can be deposited with a decorative layer 202, shown in FIG. 2. The decorative layer may be deposited by electrophoretic deposition or spray coating. The decorative layer 202 may have a thickness from about 6.0 μm to about 65.0 μm. In an example, the decorative layer 202 may have a thickness from about 10.0 μm to about 60.0 μm. In another example, the decorative layer 202 may have a thickness from about 20.0 μm to about 50.0 μm. In another example, the decorative layer 202 may have a thickness of about 35.0 μm.

The decorative layer 202 may be deposited on a portion or the whole surface of the alloy injection molded liquid metal substrate. Also, the decorative layer may be deposited onto more than one surface of the alloy injection molded liquid metal substrate. In an example, the decorative layer 202 may be deposited onto two surfaces of the alloy injection molded liquid metal substrate. In another example, the decorative layer 202 may be deposited wholly on the first surface and on a portion of the second surface of the alloy injection molded liquid metal substrate. In case of decorative layer being deposited on a portion of the surface, the decorative layer may be deposited onto at least 10% of the surface of the alloy injection molded liquid metal substrate. In an example, the decorative layer may be deposited onto at least 20% of the surface of the alloy injection molded liquid metal substrate. In an example, the decorative layer may be deposited onto at least 45% of the surface of the alloy injection molded liquid metal substrate. In an example, the decorative layer may be deposited onto at least 65% of the surface of the alloy injection molded liquid metal substrate.

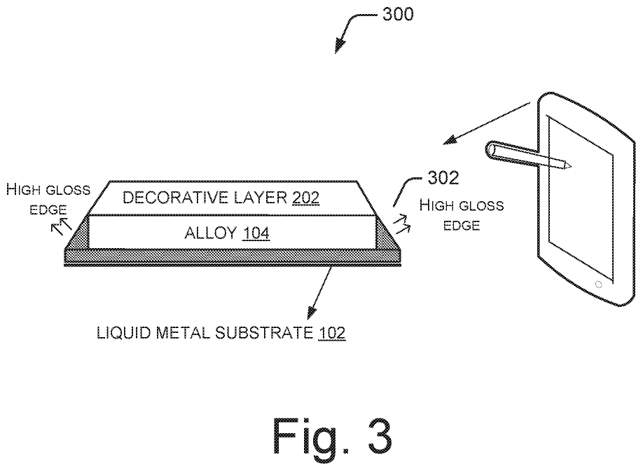

FIG. 3 illustrates an electronic device with a sectional view 300 of an alloy injection molded liquid metal substrate (comprising the alloy 104 that is injection molded on the liquid metal substrate 102) with chamfered edges 302, according to an example of the present disclosure. In an example, chamfering the alloy injection molded liquid metal substrate, may lead to enhanced gloss value from about 85 to about 97 units as measured by American Society for Testing and Materials (ASTM) D523 at a viewing angle of about 60°. In an example, the chamfering may lead to a gloss value from about 87 to about 95 units. In another example, the chamfering may lead to a gloss value of about 90 units.

As shown in FIG. 3, the enclosure 300 comprising alloy injection molded liquid metal substrate may be employed as frames or bodies of electronic devices, such as tablets, mobile phones, smart watches, laptops, and the like. In an example, the enclosure 300 comprising a decorative layer 202 deposited on the alloy injection molded liquid metal substrate may be usable as frame for tablet.

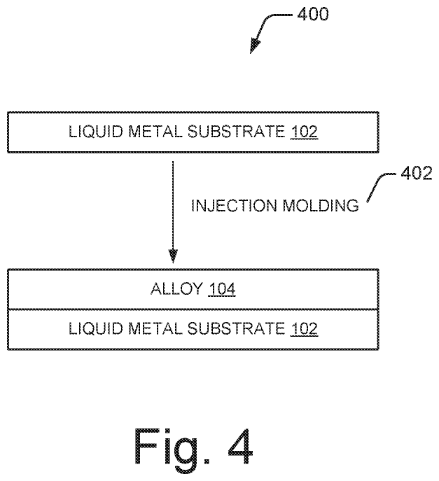

Further, details of the method of fabrication 400, i.e., injection molding an alloy on a first surface of liquid metal substrate is described with reference to FIG. 4. The alloy 104 can be injection molded onto the liquid metal substrate 102. Injection molding 402 may be carried out at a temperature from about 800° C. to about 1650° C. In an example, the injection molding may be carried out at a temperature from about 850° C. to about 1600° C. In another example, the injection molding may be carried out at a temperature from about 900° C. to about 1550° C. In another example, the injection molding may be carried out at a temperature from about 1000° C. to about 1400° C.

As shown in the FIG. 4, an alloy 104 can be molded onto a first surface of a liquid metal substrate 102. In an example, the alloy 104 may be thixomolded on the liquid metal substrate 102. In another example, the alloy 104 may be die-casted on the liquid metal substrate 102.

The alloy 104 may be molded on a portion or the whole surface of the liquid metal substrate. Also, the alloy may be molded onto more than one surface of the liquid metal substrate 102. In an example, the alloy 104 may be molded onto two surfaces of the liquid metal substrate 102. In another example, the alloy 104 may be molded wholly on the first surface and on a portion of the second surface of the liquid metal substrate 102. In case of the alloy being molded on a portion of the surface, the alloy may be injection molded onto at least 10% of a surface of the liquid metal substrate 102. In an example, alloy may be injection molded onto at least 20% of the liquid metal substrate 102. In an example, alloy may be injection molded onto at least 45% of the liquid metal substrate 102. In an example, alloy may be injection molded onto at least 65% of the liquid metal substrate 102.

In an example, the injection molding 402 may be carried out by combining the alloy selected from AZ91D, AZ31B, LZ91, ALZ991, AI6063, AI80 or combinations thereof. The mixture may be poured into the liquid metal mold at an elevated temperature from about 800° C. to about 1650° C. The molten alloy in the mold may be allowed to cool and solidify. The solidified material may be cleaned, washed, polished, degreased, and activated. The cleaning and washing may be performed using a buffer solution, which may help in removing foreign particles, if any, present on the surface of the solidified material. Further, the solidified material may be chemically polished using abrasives to remove irregularities that may be present on the surface of the solidified material. The solidified material may also be degreased through ultrasonic degreasing methods to remove impurities, such as fat, grease, or oil from the surface of the solidified material. Further, the solidified material may also be activated through acid treatment for removing the natural oxide layer, if any, present on the surface of the solidified material.

The alloy 104 may be of a thickness from about 0.3 mm to about 2.0 mm. In an example, the alloy 104 may have a thickness from about 0.5 mm to about 1.8 mm. In another example, the alloy 104 may have a thickness from about 0.5 mm to about 0.8 mm. In another example, the alloy 104 may have a thickness of about 0.6 mm.

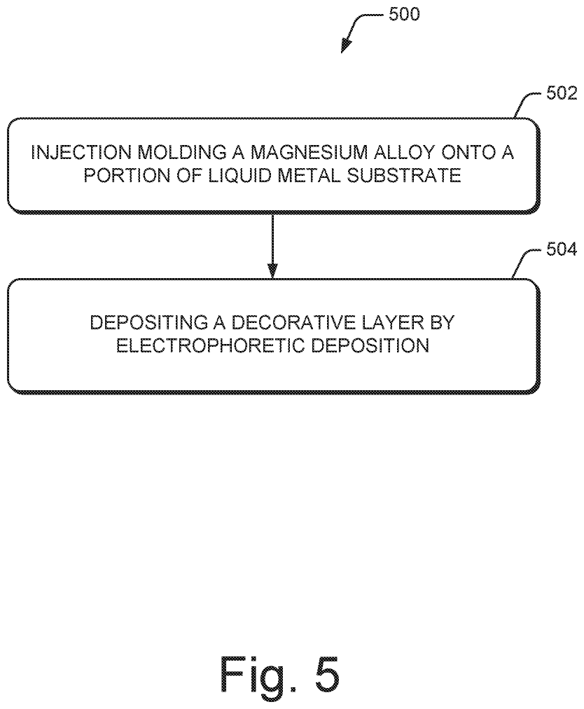

FIG. 5 illustrates a method of fabrication of an enclosure 500, wherein the enclosure comprises a decorative layer. The decorative layer may be deposited by electrophoretic deposition, as shown in FIG. 5. The decorative layer may be deposited on the alloy injection molded liquid metal substrate 502 by electrophoretic deposition 504. In an example, the electrophoretic deposition 504 may result in deposition of the decorative layer having a thickness from about 6.0 μm to about 40.0 μm. In another example, the electrophoretically deposited decorative layer 202 may have a thickness from about 10.0 μm to about 35 μm. In another example, the electrophoretically deposited decorative layer 202 may have a thickness from about 15.0 μm to about 30 μm. In another example, the electrophoretically deposited decorative layer 202 may have a thickness of about 15 μm.

The thickness of the decorative layer achieved may be directly related to the potential applied and time for electrophoretic deposition 504. In an example, the electrophoretic deposition 504 may be carried out by applying a potential in the range from about 20 to about 150 V for a period in a range from about 25 to about 120 seconds. In another example, the electrophoretic deposition 504 may be carried out by applying a potential in the range from about 50 to about 120 V for a period in a range from about 50 to about 110 seconds. In another example, the electrophoretic deposition 504 may be carried out by applying a potential of about 100 V for a period of about 70 seconds.

The decorative layer 102 deposited by electrophoretic deposition 504 may comprise copolymers selected from polyacrylate copolymer, polyacrylic acid, epoxy, polyacrylamide-acrylic acid, and combinations thereof. In an example, the decorative layer 202 may comprise copolymers of polyacrylate. In another example, the decorative layer 202 may comprise copolymers of polyacrylamide-acrylic acid.

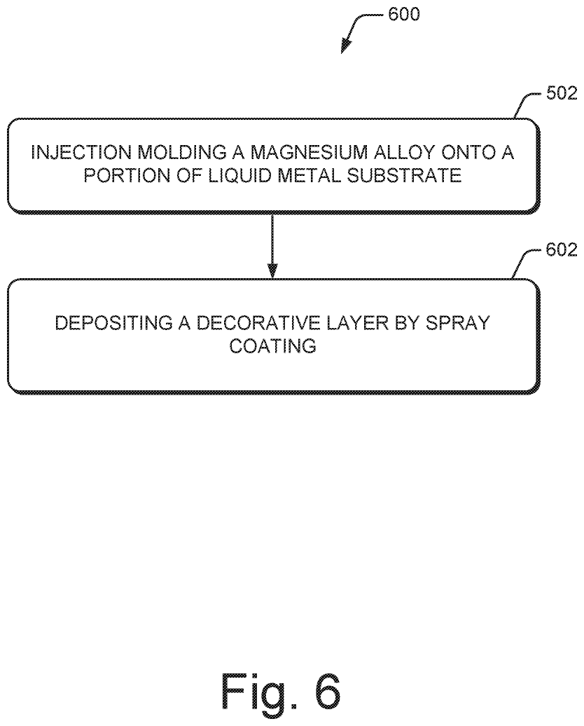

FIG. 6 illustrates a method of fabrication of an enclosure 600 comprising deposition of a decorative layer by spray coating. The decorative layer 202 may be deposited on the alloy injection molded liquid metal substrate 502 by spray coating 602. The spray coating 602 may result in deposition of decorative layer 202 having a thickness from about 25.0 μm to about 65.0 μm. In an example, the spray coated decorative layer 202 may have a thickness from about 30.0 μm to about 60.0 μm. In another example, the spray coated decorative layer 202 may have a thickness from about 35.0 μm to about 55.0 μm. In another example, the spray coated decorative layer 202 may have a thickness of about 44.0 μm.

The spray coating 602 may be carried out in a manner, whereby the decorative layer thus formed may comprise multiple layers, such as primer, base coat and top coat. In an example, the spray coated decorative layer 202 comprises sequentially deposited coats of primer having a thickness from about 5.0 μm to about 20.0 μm, followed by base coat having a thickness from about 10.0 μm to about 20.0 μm, followed by top coat having a thickness from about 10.0 μm to about 25.0 μm.

The decorative layer 202 may comprise primer, either alone or in combination with one or more other layers. The primer may also be applied as single or multiple coats to achieve desired thickness and finish. In an example, the primer may have a thickness from about 5.0 μm to about 20.0 μm. In another example, the primer may have a thickness from about 8.0 μm to about 18.0 μm. In another example, the primer may have a thickness of about 12.0 μm. In an example, the primer may be deposited on the alloy injection molded liquid metal substrate by spray coating polyurethanes followed by heat treatment at a temperature from about 60° C. to about 80° C. for period in a range from about 15 to about 40 minutes. In another example, the primer may be deposited by spray coating polyurethane followed by heat treatment at a temperature from about 62 CC to about 78° C. for period in a range from about 18 to about 38 minutes. In another example, the primer may be deposited by spray coating thermoplastics, such as polyurethanes followed by heat treatment at a temperature of about 70° C. for period of about 25 minutes.

The decorative layer 202 may comprise base coat, in combination with one or more other layers. The base coat may also be applied as single or multiple coats to achieve desired thickness and finish. In an example, the base coat may have a thickness from about 10.0 μm to about 20.0 μm. In another example, the base coat may have a thickness from about 12.0 μm to about 18.0 μm. In another example, the base coat may have a thickness of about 15.0 μm. In an example, the base coat may be a polyurethane containing pigments selected from carbon black, titanium dioxide, clay, mica, talc, barium sulfate, calcium carbonate, aluminum oxide, plastic bead, dyes, and combinations thereof. In an example, the spray coated base coat comprises polyurethane containing carbon black. In another example, the spray coated base coat comprises polyurethane containing titanium dioxide. In another example, the spray coated base coat comprises polyurethane containing clay.

In another example, the base coat deposited by spray coating followed may be by heat treatment at a temperature from about 60° C. to about 80° C. for period in a range from about 15 to about 40 minutes. In another example, the base coat deposited by spray coating may be followed by heat treatment at a temperature from about 62° C. to about 78° C. for period in a range from about 18 to about 38 minutes. In another example, the base coat deposited by spray coating may be followed by heat treatment at a temperature of about 70° C. for period of about 25 minutes.

The decorative layer 202 may comprise top coat, in combination with one or more other layers. The top coat may also be applied as single or multiple coats to achieve desired thickness and finish. In an example, the top coat may have a thickness from about 10.0 μm to about 25.0 μm. In another example, the top coat may have a thickness from about 12.0 μm to about 22.0 μm. In another example, the top coat may have a thickness of about 17.0 μm. In an example, the top coat may be made of polyacrylic acid, polyurethane, urethane acrylates, acrylic acrylates, epoxy acrylates, or combinations thereof. In an example, the top coat is made of polyacrylic acid. In another example, the top coat may be made of polyurethane. In another example, the top coat may be made of urethane acrylates.

In an example, the top coat deposited by spray coating may be followed by UV treatment in a range from about 700 mJ/cm² to about 1200 mJ/cm² for a period in a range from about 10 seconds to about 30 seconds. In another example, the top coat deposited by spray coating may be followed by UV treatment in a range from about 800 mJ/cm² to about 1100 mJ/cm² for a period in a range from about 15 seconds to about 25 seconds. In another example, the top coat deposited by spray coating may be followed by UV treatment of about 950 mJ/cm² for a period of about 20 seconds.

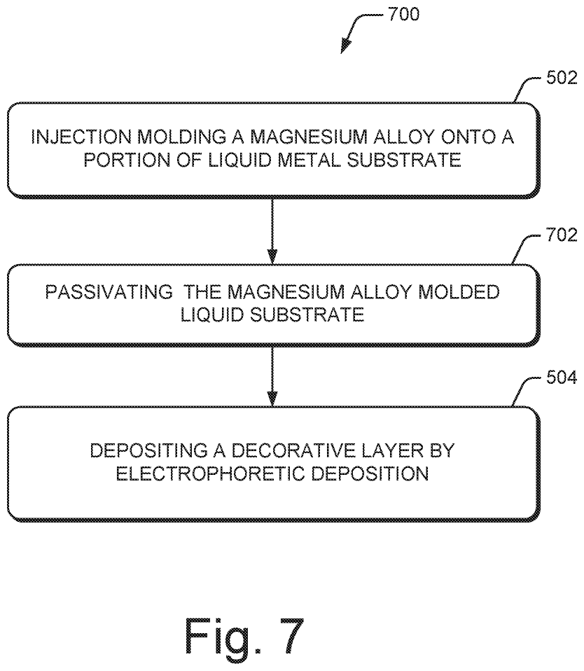

The alloy surface 104 may be cleaned, degreased, washed and passivated prior to deposition of the decorative layer. FIG. 7 illustrates a method of fabrication of an enclosure 700 comprising passivation. The alloy injection molded liquid metal substrate may be passivated 702, prior to electrophoretic deposition 504. Passivating the magnesium alloy 702 may be carried out by treating alloy injection molded liquid metal substrate with a salt of molybdate, vanadate, phosphate, chromate, stannate, manganese, or combinations thereof. In an example, passivation may be carried out by using a salt of molybdate.

### EXAMPLES

The description hereinafter describes prophetic examples, which are intended to illustrate examples of the present disclosure and not intended to be taken restrictively to imply any limitations on the scope of the present disclosure. Unless defined otherwise, all technical and scientific terms used herein have the same meaning as commonly understood to one of ordinary skill in the art to which this disclosure belongs. It is to be understood that this disclosure is not limited to the particular methods and experimental conditions described, as such methods and conditions may vary depending on the process and inputs used as will be easily understood by a person skilled in the art.

### Prophetic Example 1

A magnesium alloy (AZ91D) is injection molded on a surface of a liquid metal substrate. Said alloy has a thickness of 0.8 mm. The injection molding is carried out at a temperature of about 1200° C. by thixo-molding.

After injection molding, the alloy injection molded liquid metal substrate is subjected to chamfering using a CNC laser machine. The chamfering is done by using a laser power of about 100 W and an engraving speed of about 200 mm/minute.

### Prophetic Example 2

A magnesium alloy (AZ91D) is injection molded on a surface of a liquid metal substrate. Said alloy has a thickness of 0.8 mm. The injection molding is carried out at a temperature of about 1200° C. by thixo-molding.

After injection molding, the alloy injection molded liquid metal substrate is deposited with a decorative layer by electrophoretic deposition under a potential of 80 V for 70 seconds. The decorative layer, thus deposited contains polyacrylate and has a thickness of about 12 μm.

After deposition, chamfering is carried out using a CNC laser machine. The chamfering is done by using a laser power of about 100 W and an engraving speed of about 200 mm/minute.

### Prophetic Example 3

A magnesium alloy (AZ91D) is injection molded on a surface of a liquid metal substrate. Said alloy has a thickness of 0.6 mm. The injection molding is carried out at a temperature of about 1200° C. by thixo-molding.

After injection molding, the alloy injection molded liquid metal substrate is deposited with a decorative layer by spray coating. The decorative layer thus deposited has a thickness of about 44 μm.

The spray coating is carried out in a step-wise manner. Herein, the polyurethane primer is first deposited by spray coating followed by heat treatment at 70° C. for a period of 25 minutes. Said primer has a thickness of about 12 μm. This is followed by the deposition of a base coat made of carbon-black containing polyurethane. The deposition is carried out by spray coating followed by heat treatment at 70° C. for a period of 25 minutes. The base coat has a thickness of 15 μm. Finally, a top coat made of polyacrylic acid is applied by spray coating followed by UV treatment at 950 mJ/cm² for a period of 20 seconds. The top coat has a thickness of 17 μm.

After deposition, chamfering is carried out using a CNC laser machine. The chamfering is done by using a laser power of about 100 W and an engraving speed of about 200 mm/minute.

### Prophetic Example 4

A magnesium alloy (AZ91D) is injection molded on a surface of a liquid metal substrate. Said alloy has a thickness of 0.8 mm. The injection molding is carried out at a temperature of about 1200° C. by thixo-molding.

After injection molding, the alloy injection molded liquid metal substrate is passivated with a molybdate salt prior to deposition of decorative layer.

The deposition of a decorative layer by electrophoretic deposition is done under a potential of 80 V for 70 seconds. The decorative layer thus deposited contains polyacrylate and has a thickness of about 12 μm.

After deposition, chamfering is carried out using a CNC laser machine. The chamfering is done by using a laser power of about 100 W and an engraving speed of about 200 mm/minute.

Although examples for the present disclosure have been described in a language specific to structural features and/or methods, it is to be understood that the appended claims are not limited to the specific features or methods described herein. Rather, the specific features and methods are disclosed and explained as examples of the present disclosure.

We claim:

1. An alloy injection molded liquid metal substrate comprising:
a liquid metal substrate; and
an alloy injection molded on a first surface of the liquid metal substrate.

2. The alloy injection molded liquid metal substrate as claimed in claim 1, wherein the alloy has a thickness from about 0.3 mm to about 2.0 mm.

3. The alloy injection molded liquid metal substrate as claimed in claim 1, wherein the alloy is injection molded onto the liquid metal substrate at a temperature from about 800° C. to about 1650° C.

4. The alloy injection molded liquid metal substrate as claimed in claim 1, wherein the liquid metal substrate is made of titanium, aluminium, chromium, zirconium, tin, or combinations thereof.

5. The alloy injection molded liquid metal substrate as claimed in claim 1, wherein the alloy is a magnesium alloy selected from AZ91D, AZ31B, LZ91, ALZ991, AI6063, AI80, or combinations thereof.

6. An enclosure for an electronic device comprising:
a liquid metal substrate;
a magnesium alloy injection molded onto a portion of a surface of the liquid metal substrate; and
a decorative layer deposited on the magnesium alloy injection molded liquid metal substrate.

7. The enclosure as claimed in claim 6, wherein the decorative layer has a thickness from about 6.0 μm to about 65.0 μm.

8. The enclosure as claimed in claim 6, wherein the liquid metal substrate is made of titanium, aluminium, chromium, zirconium, tin, or combinations thereof.

9. The enclosure as claimed in claim 6, wherein:
the magnesium alloy selected from AZ91D, AZ31B, LZ91, ALZ991, AI6063, AI80 or combinations thereof, and
the magnesium alloy has a thickness from about 0.3 mm to 2.0 mm.

10. A method for fabricating an alloy injection molded liquid metal substrate, the method comprising:
injection molding a magnesium alloy onto a portion of a surface of a liquid metal substrate at a temperature from about 800° C. to about 1300° C.

11. The method as claimed in claim 10, the method comprising:
passivating the magnesium alloy injection molded liquid metal substrate with a salt of molybdate, vanadate, phosphate, chromate, stannate, manganese, or combinations thereof.

12. The method as claimed in claim 10, the method comprising:
depositing a decorative layer onto the magnesium alloy injection molded liquid metal substrate, carried out by electrophoretic deposition, to obtain an enclosure, and said decorative layer has a thickness from about 6.0 μm to about 40.0 μm.

13. The method as claimed in claim 10, the method comprising:
depositing a decorative layer onto the magnesium alloy injection molded liquid metal substrate, carried out by spray coating, to obtain an enclosure, and said decorative layer has a thickness from about 25.0 μm to about 65.0 μm.

14. The method as claimed in claim 13, wherein the decorative layer comprises:
a primer having a thickness from about 5.0 μm to about 20.0 μm;
a base coat having a thickness from about 10.0 μm to about 20.0 μm; and
a top coat having a thickness from about 0.0 μm to about 25.0 μm.

15. The method as claimed in claim 10, wherein the method comprises chamfering the enclosure to obtain high gloss edges.
